(19) United States
(12) Patent Application Publication
(10) Pub. No.: US 2012/0043470 A1
(43) Pub. Date: Feb. 23, 2012

(54) X-RAY IMAGING APPARATUS

(76) Inventors: Hao Luo, San Jose, CA (US); Carl P. Taussig, Redwood City, CA (US); Warren Jackson, San Francisco, CA (US)

(21) Appl. No.: 13/264,183

(22) PCT Filed: Apr. 15, 2009
(86) PCT No.: PCT/US09/40681

§ 371 Date: Oct. 13, 2011

(51) Int. Cl. G01T 1/24

(52) U.S. Cl. 250/370.09

(57) ABSTRACT

An X-ray imaging apparatus includes a top transparent conductive layer and a bottom transparent conductive layer electrically connected to the top transparent conductive layer. The apparatus also includes an X-ray field modulator positioned adjacent to the bottom transparent conductive layer and an electro-optic layer positioned between the X-ray field modulator and the top transparent conductive layer. The X-ray field modulator is configured to modulate one of a resistance and a charge level therethrough when exposed to different X-ray levels to thereby create different levels of voltage drop across the electro-optic layer. In addition, the different levels of voltage drop causes varying optical properties to appear in the electro-optic layer.

### BACKGROUND

X-ray imaging is widely used in medical, industry, and security systems. An example of a conventional configuration for capturing an X-ray image on film is depicted in FIG. 1. More particularly, FIG. 1 shows an X-ray source 102, a scintillator 108, and a film 110. In operation, when X-rays 104 are emitted from the X-ray source 102, the scintillator 108 converts the X-rays 104 into photons that are captured on the film 110. When a blocking object 106 is positioned in the path of the X-rays 104, the blocking object 106 blocks some of the X-rays 104 and an image 112 is formed in the film 110 from a contrast between locations in the film 110 where photons are captured and locations where photons are not captured.

Other types of X-ray imaging systems that use an Indirect Flat Panel Detector to take X-ray images instead of the film 110 have been gaining wider use. These types of systems employ an active matrix of amorphous silicon TFT as an imager that transfers the image light signals from the scintillator into electrical signals that are further digitized and processed by a computer. Although the amorphous silicon TFT panels provide good resolution and relatively high sensitivity, they are associated with relatively high manufacturing costs, especially when the panels are manufactured to have relatively large sizes.

### BRIEF DESCRIPTION OF DRAWINGS

The embodiments of the invention will be described in detail in the following description with reference to the following figures.

FIG. 1 illustrates a conventional configuration for capturing an X-ray image on film.

FIG. 2A illustrates a simplified frontal view of an X-ray imaging system, according to an embodiment of the invention;

FIG. 2B illustrates a simplified cross-sectional side view of a top transparent conductive layer depicted in FIG. 2A, according to an embodiment of the invention;

FIG. 2C illustrates a simplified frontal view of an X-ray imaging system, according to an embodiment of the invention; and

FIG. 3 illustrates a flow diagram of a method of capturing an X-ray image through use of the X-ray imaging apparatuses depicted in FIGS. 2A and 2B, according to an embodiment of the invention.

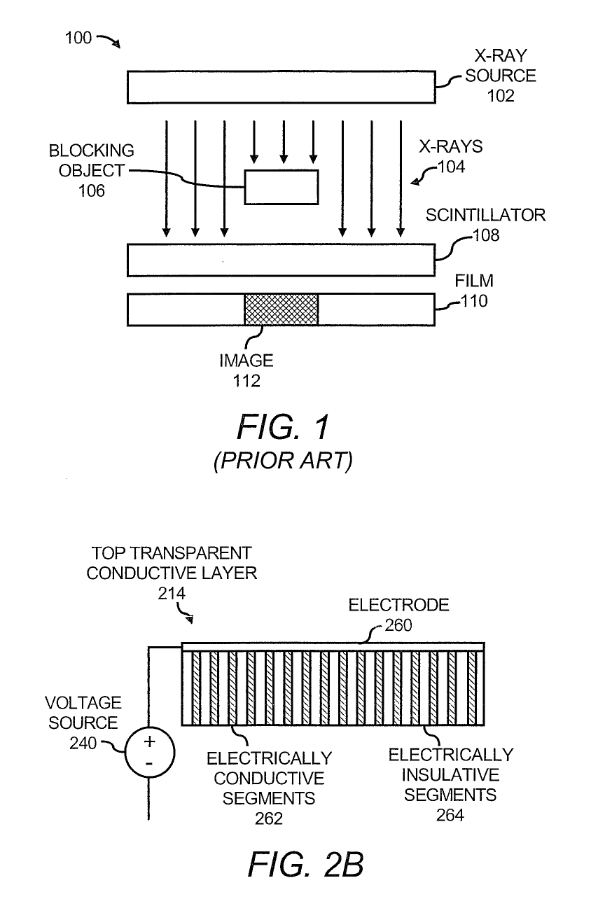

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

Disclosed herein is an X-ray imaging system having an X-ray imaging apparatus configured to cause an image of a blocking object to be displayed. The X-ray imaging apparatus includes an X-ray field modulator that is composed of a material configured to map differences in X-rays irradiated thereon by changing its resistance. The X-ray imaging apparatus also includes an electro-optic layer composed of a material that changes a visible property thereof with varying levels of voltage caused by differences in resistance in the X-ray field modulator, to thereby visibly show the differences in resistance in the X-ray field modulator.

Through implementation of the X-ray imaging apparatus disclosed herein, an instant X-ray image may be achieved. In addition, the visible image may easily be digitized by normal digital cameras and thus expensive large active TFT panels are not required. Moreover, fabrication of the X-ray imaging apparatus disclosed herein is associated with relatively low costs due to its relatively simple architecture. One result of this relatively low costs is that the X-ray imaging apparatus disclosed herein may be employed in relatively large-scale X-ray imaging operations, such as, imaging of entire human bodies, shipping containers, etc., in addition to use in smaller medical imaging operations.

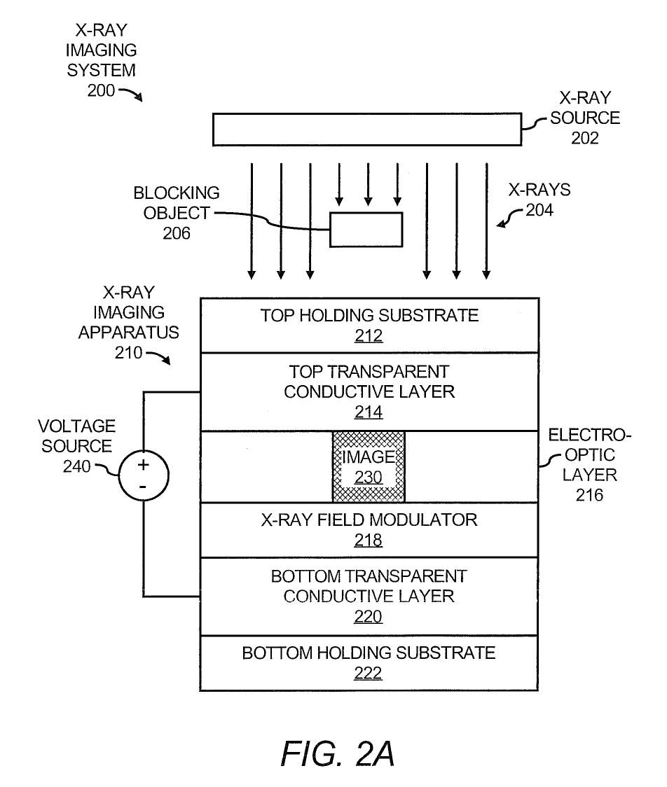

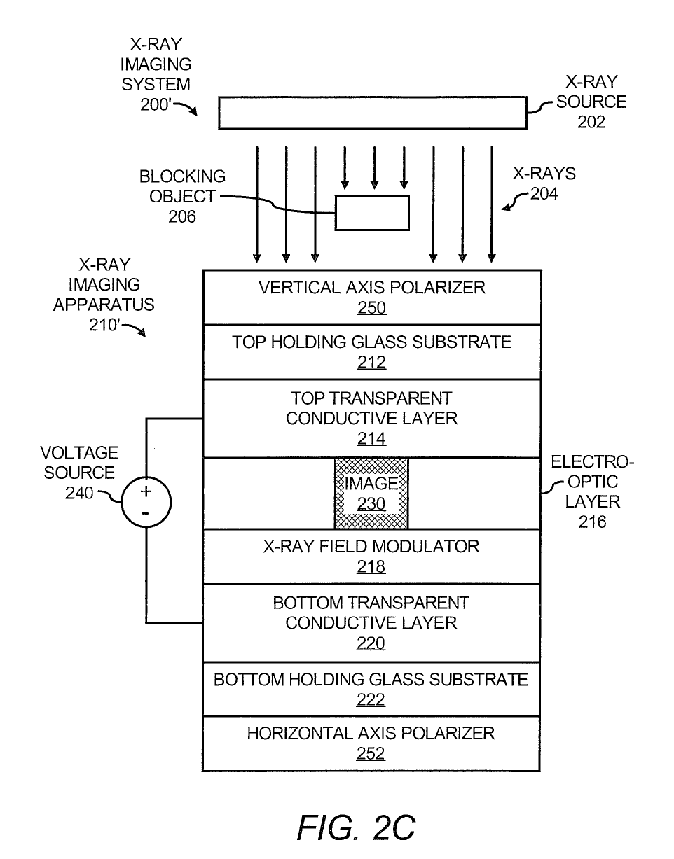

With reference first to FIG. 2A, there is shown a simplified frontal view of an X-ray imaging system 200, according to an example. It should be understood that the X-ray imaging system 200 may include additional elements and that some of the elements described herein may be removed and/or modified without departing from a scope of the X-ray imaging system 200.

As shown in FIG. 2A, the X-ray imaging system 200 includes an X-ray source 202 and an X-ray imaging apparatus 210. The X-ray source 202 may comprise an X-ray tube or other device configured to irradiate X-rays 204 in the direction of the X-ray imaging apparatus 210. Although not shown, a collimator may be positioned between the X-ray source 202 and the X-ray imaging apparatus 210 to generally limit the range of X-ray irradiation in directions other than toward the X-ray imaging apparatus 210.

A blocking object 206 is also depicted as being positioned between the X-ray source 202 and the X-ray imaging apparatus 210. The blocking object 206 depicted in FIG. 2A generally represents an object, an article, a person or person's body part, etc., that is configured to be imaged using the X-ray imaging system 200.

The X-ray imaging apparatus 210 is depicted as being formed of a number of components arranged in a layered structure. More particularly, the X-ray imaging apparatus 210 is depicted as including a top holding substrate 212, a top transparent conductive layer 214, an electro-optic layer 216, an X-ray field modulator 218, a bottom transparent conductive layer 220, and a bottom holding substrate 222. The layers of the X-ray imaging apparatus 210 may be held together through frictional forces or through use of transparent adhesives that do not substantially affect the transmission of X-rays 204 through the X-ray imaging apparatus 210. In addition, or alternatively, the layers of the X-ray imaging apparatus 210 may be held together through use of mechanical fasteners or other mechanical devices. At least some of the layers of the X-ray imaging apparatus 210 requires a relatively high level of electrical conduction there between. For instance, a relatively high level of electrical conduction between the top transparent conductive layer 214 and the electro-optic layer 216 is preferable. To provide the relatively high level of electrical conduction, the top transparent layer 214 may be deposited onto the electro-optic layer 216.

The top holding substrate 212 and the bottom holding substrate 222 generally provide support and protection to components of the X-ray imaging apparatus 210. The top holding substrate 212 and the bottom holding substrate 222 comprise transparent devices configured to enable light and X-rays to penetrate therethrough. The top holding substrate 212 and the bottom holding substrate 222 are formed of glass, plastic, or like material.

The top transparent conductive layer 214 and the bottom transparent conductive layer 220 are generally configured to enable X-rays 204 and light to pass therethrough. In addition, the top transparent conductive layer 214 and the bottom transparent conductive layer 220 are connected together through a voltage source 240 and are configured to operate as electrodes by conducting electricity from the voltage source 240 through the electro-optic layer 216 and the X-ray filed modulator 218. According to an example, the top transparent conductive layer 214 and the bottom transparent conductive layer 220 are formed of indium tin oxide (ITO) or equivalent material.

According to an example, one or both of the top transparent conductive layer 214 and the bottom transparent conductive layer 220 are electrically segmented. More particularly, FIG. 2B shows an example of the top transparent conductive layer 214 having alternating sections of electrically conductive segments 262 and electrically insulative segments 264 running from the top to the bottom of the transparent conductive layer 214, 220, with the electrically conductive segments 262 in electrical contact with an electrode 260. In instances where the bottom transparent conductive layer 220 is segmented, the bottom transparent conductive layer 220 may have a similar arrangement to that depicted for the transparent conductive layer 214, except that the electrode 260 will be positioned at the bottom section of the bottom transparent conductive layer 220. In various examples, the electro-optic layer 216 may also be configured to have the electrically conductive segments 262 and the electrically insulative segments 264.

The electrically conductive segments 262 may be sized according to the level of resolution desired in images 230 formed the electro-optic layer 216. Thus, for instance, the electrically conductive segments 262 may have relatively smaller sizes and positioned relatively close together when higher resolution images 230 are desired. By way of particular example, the electrically conductive segments 262 may comprise relatively thin discrete elements and the electrically insulative segments 264 may comprise an insulative layer deposited around the electrically conductive segments 262. Alternatively, the electrically insulative segments 264 may be fabricated with holes into which the electrically conductive segments 262 are deposited or positioned.

The electro-optic layer 216 generally comprises a material that is transparent to X-rays 204 and configured to display different levels of contrast depending upon, for instance, the level of voltage applied therethrough. Thus, when a relatively consistent level of voltage is applied through the entire electro-optic layer 216, the electro-optic layer 216 displays a substantially even image throughout. However, when the voltage varies for a section of the electro-optic layer 216, such as by a voltage drop, that section of the electro-optic layer 216 has a different contrast as compared with the remainder of the electro-optic layer 216. As discussed in greater detail herein below, one or more sections in line with a blocking object 206 may experience a voltage drop as compared with the rest of the electro-optic layer 216, which causes an image 230 corresponding to the blocking object 206 to be displayed in the electro-optic layer 216.

According to an example, the electro-optic layer 216 comprises a bi-stable material that enables the image 230 to be persistently displayed following removal of voltage. In this example, the electro-optic layer 216 may comprise at least one of an electrophoretic and a cholesteric material. Examples of suitable materials include materials available from the E-Ink Corporation of Cambridge, Mass. and from Sipix of Fremont, Calif. and Bridgestone of Tokyo, Japan.

According to another example, the electro-optic layer 216 comprises a material that is configured to cause the image 230 to be removed from the electro-optic layer 216 when the voltage is removed. In this example, the electro-optic layer 216 may comprise a material composed of twisted nematic liquid crystals. An X-ray imaging apparatus 210′ having an electro-optic layer 216 composed of twisted nematic liquid crystals is discussed in greater detail herein below with respect to FIG. 2B.

The X-ray field modulator 218 is generally configured to generate electron hole pairs when exposed to X-rays 204. The X-ray field modulator 218 is thus required to have a relatively strong interaction with the X-rays 204. Examples of suitable materials are high Z materials, for instance, one or more elements from the bottom of the periodic chart. In operation, the X-ray field modulator 218 is configured to vary the resistance through the X-ray field modulator 218 when exposed to X-rays 204, such that, the resistance of the X-ray field modulator 218 at locations that are blocked by the blocking object 206 differs from those locations that are not blocked by the blocking object 206. The differences generally form a voltage map across the X-ray field modulator 218 that indicates the shape of the blocking object 206. In this regard, the electro-optic layer 216 and the X-ray field modulator 218 generally operates as a voltage divider between the top transparent conductive layer 214 and the bottom transparent conductive layer 220.

The differences in resistance at the locations of the X-ray field modulator 218 as denoted by the voltage map is reflected in the electro-optic layer 216 because the electro-optic layer 216 creates a visual representation of the voltage map. More particularly, for instance, there will be a voltage drop below the blocking object 206 that differs from a voltage drop across locations that are not below the blocking object 206. In addition, because the optical properties of the electro-optic layer 216 depend upon the voltage drop level, the regions in the electro-optic layer 216 beneath the blocking object 206 will appear differently from the regions that are not beneath the blocking object 206.

According to an example, the X-ray field modulator 218 comprises a relatively thick material having a relatively high-z value and configured to block about 50% of the X-rays 204. Examples of suitable materials include gadolinium, sodium iodide activated by thallium (NaI:Tl), Yttirum aluminum perovskite activated by cerium (YAP:Ce), Yttrium aluminum garnet activated by cerium (YAG:Ce), Bismuth germanate (BGO), Calcium fluoride activated by Europium (CaF:Eu), Cesium iodide activated by thallium (CsI:Tl), Lutelium aluminum garnet activated by cerium (LuAG:Ce), Gadolinium silicate doped with cerium (GSO), Cadmium tungstate CdWO4 (CWO), Lead tungstate PbWO4 (PWO), Double tungstate of sodium and bismuth NaBi(WO4)2) (NBWO), ZnSe(Te), and the like. Other suitable materials include chalcogenides, such as, selenium, arsenic tri-solenide, or the like.

According to another embodiment, the X-ray field modulator comprises a charge node, such as a PIN diode in reverse bias. In this embodiment, instead of a current flowing through the X-ray field modulator 218, charge is created within the X-ray field modulator 218 and is separated by the internal field of the PIN device thereby changing the field across the electro-optic layer 216. The charge on the X-ray field modulator 218 exhibits spatial variation depending upon whether a blocking object 206 blocks the X-rays 204. In addition, the charge in the electro-optic layer 216 beneath the blocking object 206 will differ from the charge in the electro-optic layer 216 in sections that are not beneath the blocking object 206, which causes the optical properties of the electro-optic layer 216 to differ in those sections.

Turning now to FIG. 2C, there is shown a simplified frontal view of an X-ray imaging system 200′, according to another example. It should be understood that the X-ray imaging system 200′ may include additional elements and that some of the elements described herein may be removed and/or modified without departing from a scope of the X-ray imaging system 200′.

The X-ray imaging system 200′ depicted in FIG. 2C contains all of the elements discussed above with respect to the X-ray imaging system 200 depicted in FIG. 2A. As such, a detailed discussion of the common elements are omitted with respect to FIG. 2C. Instead, only those elements that differ from the elements depicted in FIG. 2C will be described.

The principle difference between the X-ray imaging systems 200 and 200′ is that the electro-optic layer 216 depicted in FIG. 2C comprises twisted nematic liquid crystals. As such, the X-ray imaging apparatus 210′ further includes a vertical axis polarizer 250 and a horizontal axis polarizer 252 to enable images 230 in the electro-optic layer 216 to be visible.

According to an example, the X-ray imaging apparatuses 210, 210′ are designed for single use applications, and may thus be discarded after their use. In another example, however, the X-ray imaging apparatuses 210, 210′ are designed for multiple uses and the electro-optic layer 216 may be configured such that the image 230 may be “erased” from the electro-optic layer 216 between each use. The manners in which the image 230 may be “erased” from the electro-optic layer 216 may depend upon the materials and/or configuration of the electro-optic layer 216, the voltage source waveform, polarity, etc. By way of example, when the electro-optic layer 216 is unable to maintain the image 230 when the voltage supply is cut off, such as, with twisted nematic liquid crystals, the image 230 may be erased by simply turning off the voltage supply to the top and bottom transparent conductive layers 214 and 220.

However, in instances where the electro-optic layer 216 comprises a bi-stable material and/or configuration, the image 230 may be erased by applying a reverse bias voltage across the electro-optic layer 216. In various instances, the image 230 may be erased through application of a sufficiently high voltage for a sufficiently long period of time to cause the image 230 in the electro-optic layer to saturate into one state, for instance, an even white color.

In any regard, an image of the image 230 may be captured through use of a digital camera (not shown). According to an example, the image 230 may be viewed and captured through the top transparent conductive layer 214. In this example, the line of sight of the digital camera is directed toward the top of the X-ray imaging apparatus 210, 210′. In addition, the digital camera may be incorporated with the X-ray source 202 such that the digital camera may be employed to capture the image of the image 230 while the X-ray source 202 is active or immediately after the X-ray source 202 has been deactivated. In a further example, the X-ray imaging apparatus 210, 210′ may be moved to another location to be imaged by the digital camera after having been irradiated with the X-rays 204.

According to another example, the image 230 may be viewed and captured through the bottom transparent conductive layer 220. In this example, because the X-ray field modulator 218 is opaque, the X-ray field modulator 218 may be formed to have a mesh structure to enable at least a relatively high level of light to pass therethrough. In addition, any other opaque sections of the X-ray imaging apparatus 210, 210′ may be formed to have a mesh structure to enable light to pass therethrough. Again, the digital camera may be used to capture the image 230 while the X-ray source 202 is active or after the X-ray source 202 has been deactivated. The mesh structure(s) may also be employed in a configuration in which the X-ray source 202 is positioned to irradiate X-rays 204 from the bottom of the X-ray imaging apparatus 210, 210′.

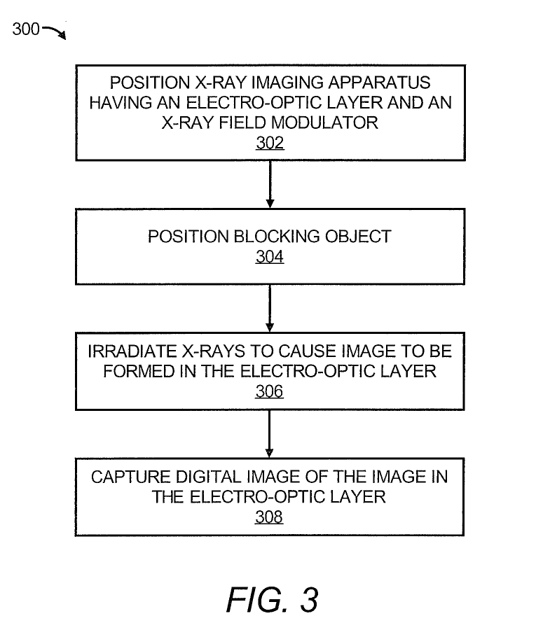

An example of a method of capturing an X-ray image through use of the X-ray imaging apparatus 210, 210′ will now be described with respect to the following flow diagram of the method 300 depicted in FIG. 3. It should be apparent to those of ordinary skill in the art that the method 300 represents a generalized illustration and that other steps may be added or existing steps may be removed, modified or rearranged without departing from a scope of the method 300.

The description of the method 300 is made with reference to the X-ray imaging systems 200, 200′ illustrated in FIGS. 2A and 2B, and thus makes reference to the elements cited therein. It should, however, be understood that the method 300 is not limited to the elements set forth in the X-ray imaging systems 200, 200′. Instead, it should be understood that the method 300 may be practiced by a system having a different configuration than that set forth in the X-ray imaging systems 200, 200′.

At step 302, an X-ray imaging apparatus 210, 210′ is positioned to receive X-rays 204 from an X-ray source 202. The X-ray imaging apparatus 210, 210′ includes an electro-optic layer 216 and an X-ray field modulator 218. As discussed above, the X-ray field modulator 218 is configured to vary at least one of a voltage and a charge through the electro-optic layer when irradiated with X-rays 204.

At step 304, a blocking object 206 is positioned between the X-ray source 202 and the X-ray imaging apparatus 210, 210′. The blocking object 206 comprises the object whose image 230 is to be captured in the X-ray imaging apparatus 210, 210′.

At step 306, X-rays 204 are irradiated through the X-ray imaging apparatus 210, 210′ from the X-ray source 202 to cause an image 230 of the blocking object 206 to be formed in the electro-optic layer 216. As discussed in greater detail herein above, the image 230 may be formed through changes in either the voltage or the charge throughout the X-ray field modulator 218 caused by different levels of X-rays 204 being irradiated onto the X-ray field modulator 218. In addition, the image 230 may be persistently or temporarily formed in the electro-optic layer 216.

At step 308, a digital image of the image 230 in the electro-optic layer 216 is captured through use of a digital camera. As discussed in greater detail herein above, the image may be captured through the top and/or the bottom of the X-ray imaging apparatus 210, 210′.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

1. An X-ray imaging apparatus comprising:
a top transparent conductive layer;
a bottom transparent conductive layer, wherein the bottom transparent conductive layer is electrically connected to the top transparent conductive layer;
an X-ray field modulator positioned adjacent to the bottom transparent conductive layer; and
an electro-optic layer positioned between the X-ray field modulator and the top transparent conductive layer, wherein the X-ray field modulator is configured to modulate one of a resistance and a charge resistance level therethrough when exposed to different X-ray levels to thereby create different levels of voltage drop across the electro-optic layer, and wherein the different levels of voltage drop causes varying optical properties to appear in the electro-optic layer.

2. The X-ray imaging apparatus according to claim 1, further comprising:
a top holding substrate positioned above the top transparent conductive layer; and
a bottom holding substrate positioned below the bottom transparent conductive layer.

3. The X-ray imaging apparatus according to claim 1, wherein the electro-optical layer comprises a material from the group consisting of an electrophoretic and a cholesteric material.

4. The X-ray imaging apparatus according to claim 1, wherein the electro-optical layer comprises twisted nematic liquid crystals.

5. The X-ray imaging apparatus according to claim 4, further comprising:
a vertical axis polarizer positioned above the top transparent conductive layer; and
a horizontal axis polarizer positioned below the bottom transparent conductive layer.

6. The X-ray imaging apparatus according to claim 1, wherein the electro-optic layer is configured to display the image persistently when a voltage application is ended.

7. The X-ray imaging apparatus according to claim 1, wherein the electro-optic layer is configured to cause the image to be removed when a voltage application is changed.

8. The X-ray imaging apparatus according to claim 1, wherein the X-ray field modulator comprises a material having a relatively high-z material.

9. The X-ray imaging apparatus according to claim 1, wherein the X-ray field modulator is composed of a material selected from the group consisting of gadolinium, NaI:Tl, YAP:Ce, YAG:Ce, BGO, CaF:Eu, CsI:Tl, LuAG:Ce, GSO, CWO, PWO, NBWO, ZnSe(Te) selenium, and arsenic tri-solenide.

10. The X-ray imaging apparatus according to claim 1, wherein the X-ray field modulator comprises at least one PIN diode.

11. The X-ray imaging apparatus according to claim 1, wherein the X-ray field modulator comprises a mesh structure.

12. An X-ray imaging system according to claim 1, said X-ray imaging system further comprising:
an X-ray source configured to irradiate X-rays toward the X-ray imaging apparatus.

13. The X-ray imaging system according to claim 12, further comprising:
an image capture device configured to capture an image of the varying levels of contrast in the electro-optic layer.

14. A method of capturing an X-ray image, said method comprising:
positioning an X-ray imaging apparatus to receive X-rays from an X-ray source, said X-ray imaging apparatus having an electro-optic layer and an X-ray field modulator, wherein the X-ray field modulator is configured to vary at least one of a voltage and a charge through the electro-optic layer when irradiated with X-rays;
positioning a blocking object between the X-ray source and the X-ray imaging apparatus; and
irradiating X-rays from the X-ray source to the X-ray imaging apparatus to cause an image pertaining to the blocking object to be formed in the electro-optic layer based upon at least one of a voltage difference and a current difference in the electro-optic layer caused by the X-ray filed modulator.

15. The method according to claim 14, further comprising:
capturing a digital image of the image in the electro-optic layer.
